(19) United States
(12) Patent Application Publication
(10) Pub. No.: US 2009/0309047 A1
(43) Pub. Date: Dec. 17, 2009

(54) PARTICLE THERAPY SYSTEM

(76) Inventors: Konstanze Gunzert-Marx, Erlangen (DE); Thomas Hansmann, Heidelberg (DE); Werner Kaiser, Erlangen (DE); Tobias Muller, Erlangen (DE)

Correspondence Address: BRINKS HOFER GILSON & LIONE, P.O. BOX 10395, CHICAGO, IL, 60610, US

(21) Appl. No.: 12/482,941

(22) Filed: Jun. 11, 2009

(30) Foreign Application Priority Data
Jun. 16, 2008 (DE) 10 2008 028 510.2

(51) Int. Cl. B01J 19/12; B23P 11/00

(52) U.S. Cl. 250/492.3; 29/428

(57) ABSTRACT

The present embodiments relate to a particle therapy system having an accelerator unit for providing a particle beam and having a particle beam transport system for guiding the particle beam. The particle beam transport system has a first subarea by which the particle beam can be guided out from a level of the accelerator unit. A gantry-based radiation room is connected to the first subarea of the particle beam transport system. The present embodiments may also relate to a particle therapy system having foundations, where the foundations are dimensioned at one point such that a gantry-based radiation room can be retrofitted at the one point. In particular the foundations at the one point are located essentially at the same height as the foundations underneath an accelerator unit and/or underneath a particle beam transport system.

The present patent document claims the benefit of the filing date of DE 10 2008 028 510.2, filed Jun. 16, 2008, which is hereby incorporated by reference.

### BACKGROUND

The present embodiments relate to retrofitting a particle therapy system.

Particle therapy systems are used for treating tumor diseases. Particle therapy is a method for treating tissue, such as tumor diseases. Irradiation methods used in particle therapy are also used in non-therapeutic fields, however. These non-therapeutic fields include, for example, particle therapy research activities that are carried out on non-living phantoms or bodies, irradiation of materials, etc. Charged particles, such as protons or carbon ions or other types of ions, are accelerated to high energies, formed into a particle beam, and guided via a high-energy beam transport system to one or more radiation rooms. Once in the radiation room, the object that is to be irradiated is irradiated with the particle beam.

Radiation rooms can be radiation rooms having a fixed beam modulator or as radiation rooms having a gantry. In radiation rooms having a fixed beam modulator, the particle beam is guided by the particle beam transport system in a spatially stationary manner into a radiation room. In this case it is also possible for a radiation room to have a plurality of stationary beam modulators, and for the particle beam to be optionally guided into the radiation room via one of the beam modulators. Radiation rooms, as described above, are disclosed, for example, from the publication by Mizota et al. titled “The High-Energy Beam transport System for HIMAC”, Mitsubishi Electric Advance, Mitsubishi Electric Corporation, Tokyo, Japan, Vol. 62, 1995, pp. 2-4.

Gantry-based radiation rooms afford the possibility of guiding the particle beam into the radiation room from different selectable angles. The particle beam transport system may be embodied in the last section before the beam modulator in such a way that the last section can be rotated with the aid of a gantry. The angle of the beam modulator can be set by rotation of the gantry. Gantry-based radiation rooms offer a greater degree of freedom for the irradiation.

When protons and heavy ions are accelerated in a particle therapy system, the design of a gantry represents a significant challenge. This is because the increased rigidity of the particle beam requires higher magnetic fields, which results in the magnets used in the gantry having a considerable weight and in the gantry having a large diameter. The comparatively large amount of overhead associated with a gantry-based radiation room increases the difficulty and complexity of planning and building a particle therapy system.

A gantry may be equipped with superconducting magnets, which would lead to a reduction in the weight and size of the gantry. Solutions of this kind have so far not been implemented in practice, however. Precise specifications of a gantry of this type are not known. Implementing this solution additionally harbors the risk that unexpected problems will occur and have to be overcome.

U.S. Pat. No. 6,894,300 B2 discloses the concept of expanding a particle therapy system using a second ion beam system.

### SUMMARY AND DESCRIPTION

The present embodiments may obviate one or more of the drawbacks or limitations in the related art. For example, the present embodiments may related to providing a particle therapy system and a method for building such a system which allow easy planning and easy construction, in particular when the system is to include a gantry-based radiation room. A method for retrofitting a particle therapy system may also be provided. The method may be used to enable the retrofitting to be carried out in a simple manner.

In one embodiment, the particle therapy system may include an accelerator unit and a particle beam transport system. The accelerator unit may accelerate particles and provide a particle beam. The particle beam transport system may guide the particle beam provided by the accelerator unit. The particle beam transport system may include a first subarea by which the particle beam can be guided out from a level on which the accelerator unit is located. The gantry-based radiation room is connected to the first subarea of the particle beam transport system.

Connecting a gantry-based radiation room to the accelerator unit at the same height can sometimes be problematic because the axis of rotation of the gantry essentially lies at the same height as the accelerator unit. If the accelerator unit is, for example, a synchrotron or cyclotron, the height is defined by the plane of the synchrotron ring or of the cyclotron. A gantry-based radiation room having an axis of rotation that lies at this height creates the problem that the gantry-based radiation room must be set considerably deeper on account of the projecting gantry than, for example, other radiation rooms or rooms for the accelerator. For the foundations of a building, the foundations are sunk deeper at least at the site of the gantry-based radiation room. This may be problematic when the gantry-based radiation room is to be retrofitted. The foundations would have to be excavated retrospectively to a greater depth at great expense, which, owing to the sensitivity of the system, can also result in downtimes or be planned and built to be deep enough from the outset to allow the retrofit. The latter may only be planned with a large measure of uncertainty if the gantry specifications are not known precisely. The specifications of a gantry that may not be known in every detail include the overall installation dimensions, the floor area and the height of the required room and the position of the axis of rotation, which may be referred to as the central axis of the gantry.

Even without retrofitting, however, the costs for the construction of the building are lower if the foundations are set to a lower depth. Foundations (or footings, as they are also called) may include the structural and static embodiment of the transition from the structure to the ground so that the deformations of the ground caused by the structure and the load are less than is permissible from the viewpoint of the structure. In particle therapy, the foundations are of critical importance owing to the high requirements with regard to the precision of the beam guidance.

The gantry-based radiation room may be connected to a subarea of the particle beam transport system. The subarea may guide the particle beam out from the level on which the accelerator unit is arranged. The subareas of the particle beam transport system are often already present or planned in order, for example, to supply a radiation room having a plurality of stationary beam modulators having a horizontal and a vertical beam modulator. For the vertical beam modulator, the particle beam transport system may initially be routed upward from the accelerator and subsequently from the top vertically downward again into the vertical beam modulator. As a result, the (horizontal) axis of rotation of the gantry is positioned higher than the spatially fixed accelerator unit. The gantry-based radiation room may include that section of the beam transport system may be movable. In other words, the beam transport system may be connected to the spatially fixed part of the beam transport system.

The gantry-based radiation room may be connected to a subarea of the particle beam transport system. As a result, it is possible, with comparatively little overhead, to connect the radiation room to the particle beam transport system at a height which lies above the level of the accelerator unit. The axis of the gantry may be positioned higher than the accelerator unit. As a result, a less deeply sunk foundation is required for the gantry-based radiation room. This may permit the gantry components that are to be retrofitted to be introduced at ground level at the level of the accelerator, without deeper groundwork excavations to expose, for example, service openings.

In particular the gantry-based radiation room may have a gantry radius that is equal to or less than the height difference between the entry point of the particle beam transport systems into the gantry and the level (e.g., location or height) on which the accelerator unit is located. The gantry radius enables the gantry-based radiation room to be disposed on the foundations even when the foundations are no deeper than is necessary for the accelerator unit.

In one embodiment, the particle therapy system includes at least one further radiation room that is connected to a second subarea of the particle beam transport system. The second subarea transports the particle beam essentially on the level on which the accelerator unit is also disposed. Radiation rooms are usually radiation rooms which have a stationary horizontal beam modulator and are arranged on the same plane as the accelerator unit. In this embodiment, no vertical deflection of the particle beam by the particle beam transport system is necessary.

In one embodiment, the first subarea of the particle beam transport system is designed such that the subarea has a section by which the particle beam can be guided essentially horizontally. For example, in the first subarea, the particle beam may be initially guided out from the plane of the accelerator unit and subsequently, after the particle beam has been guided to a certain height, may be guided further parallel to the plane of the accelerator unit. The gantry-based radiation room may be connected to the horizontally routed section of the first subarea.

In another embodiment, the particle therapy system may include a plurality of rooms which are disposed on foundations. The foundations are dimensioned from the outset at one point in such a way that a gantry-based radiation room can be retrofitted at this point. The space for the foundations at this point in the horizontal direction is so great that a gantry-based radiation room will have room on the foundations. The strength of the foundations at this point (location) is chosen such that at this point the foundations will be able to support a typical gantry-based radiation room in spite of the increased weight and at the same time will ensure a building stability that is necessary for the irradiation. At the time at which the gantry-based radiation room is retrofitted, considerably less expenditure for retrofitting is necessary. The foundations do not have to be specially reinforced for retrofitting.

A radiation room having a stationary beam modulator, for example, can be disposed at the point at which a gantry-based radiation room will possibly be retrofitted in the future, until such time as the retrofitting takes place, with the result that optimal use is made of the space until the time of retrofitting.

The foundations may be located at or essentially located at the same height as the foundations that are located underneath an accelerator unit and/or underneath a particle beam transport system. This is particularly simple to accomplish structurally. As a result, it is not necessary in this building phase to take detailed account of a possible height or other specifications of the gantry that is to be retrofitted, which details may possibly not be precisely known at this time. The height of a gantry-based radiation room may be taken into account in a later phase, when the gantry is connected to a subarea of the particle beam transport system which lies above the accelerator unit. A variation in the connection height of the gantry in the upward direction is easier to accomplish structurally than a displacement of the foundations downward.

Accordingly, the particle beam transport system advantageously will, from the outset, already have a first subarea by which the particle beam is guided out from a level on which the accelerator unit is disposed. At the time of retrofitting, the connection to the first subarea may take place.

In one embodiment, a method for building a particle therapy system is provided. The method may include providing an accelerator unit for the purpose of accelerating particles and for providing a particle beam, providing a particle beam transport system for guiding the particle beam provided by the accelerator unit. The particle beam transport system has a first subarea by which the particle beam may be guided out from a level on which the accelerator unit is located. A gantry-based radiation room is connected to the first subarea of the particle beam transport system.

The connection of the gantry-based radiation room takes place on a level which lies above the accelerator unit. The particle beam may be guided in the first subarea of the particle beam transport system vertically upward or obliquely vertically upward.

The method for retrofitting a particle therapy system, which particle therapy system has an accelerator unit for accelerating particles and for providing a particle beam, and a particle beam transport system for guiding the particle beam provided by the accelerator unit, is provided. The particle beam transport system has a first subarea by which the particle beam can be guided out from a level on which the accelerator unit is located. A radiation room, in particular a gantry-based radiation room, may be connected to the first subarea of the particle beam transport system.

Embodiments as have been explained in the case of the particle therapy system can also be used for the method for building a particle therapy system as well as for the method for retrofitting a particle therapy system.

### BRIEF DESCRIPTION OF THE DRAWINGS

FIG. 1 shows one embodiment of a particle therapy system that is configured for retrofitting with a gantry-based radiation room, and

FIG. 2 shows a schematic side view of a particle therapy system that has a gantry-based radiation room.

### DETAILED DESCRIPTION

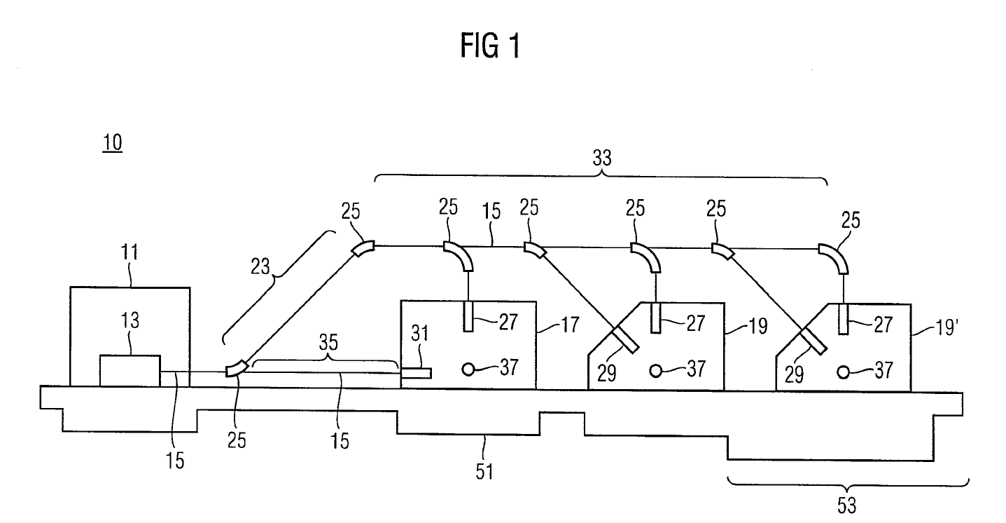

FIG. 1 shows a particle therapy system 10 in a schematic side view. Located in a first section 11 is the accelerator unit 13 by which charged particles are generated and accelerated to the energy necessary for irradiation purposes, and by which a particle beam is formed.

After having been provided by the accelerator unit 13, the particle beam enters the particle beam transport system 15. The particle beam is guided, using the transport system 15, from the accelerator unit 13 to the radiation rooms 17, 19, 19′. Any deflection of the particle beam may be necessary is effected by a suitable setting of the various deflection magnets 25 in the particle beam transport system.

Immediately after the particle beam enters the particle beam transport system 15, given an appropriate setting of the deflection magnets 25, the particle beam may be guided into a first subarea 23 of the particle beam transport system 15, as a result of which the particle beam is guided out from the level of the accelerator unit 13 diagonally upward. After the particle beam has been guided to a certain height, for example, to a height of over 6 m to typically 10 m, the particle beam is once again guided horizontally in a section 33 of the first subarea 23. From this section 33, the particle beam may be deflected such that the particle beam can be directed, for example, into the first radiation room 17 via a vertical beam modulator 27 vertically downward onto a target object 37. This is also possible in the second radiation room 19 and the third radiation room 19′. In the case of the second and third radiation rooms 19, 19′ it is alternatively possible to direct the particle beam onto the target object 37 via a diagonal beam modulator 29.

The particle beam may be guided in the particle beam transport system 15 but not into the first subarea 23. The particle beam may continue running without vertical deflection on the plane of the accelerator unit 13 in a second subarea 35 and can be directed onto the target object 37 that is to be irradiated via a horizontal beam modulator 31 in the first radiation room 17.

Depending on the embodiment of the particle beam transport system 15, the particle beam transport system 15 may be routed in such a way that the second radiation room 19 and/or the third radiation room 19′ have/has a horizontal beam modulator 31.

FIG. 1 shows the building foundations 51 on which the rooms of the particle therapy system 10 are erected. The building foundations 51 are dimensioned and embodied in such a way that the load of the particle therapy system 10 does not lead to a critical deformation which would disrupt the operation of the particle therapy system 10.

Under the third radiation room 19′, the building foundations 51 are dimensioned significantly greater, both in terms of the strength of the building foundations and in terms of horizontal extension, than would be necessary for the radiation room 19′.

This has the advantage that at this point (location) 53 a gantry-based radiation room can be retrofitted without carrying out major, substantial alteration measures to the foundations 51 themselves. For retrofitting purposes the third radiation room 19′ will be removed.

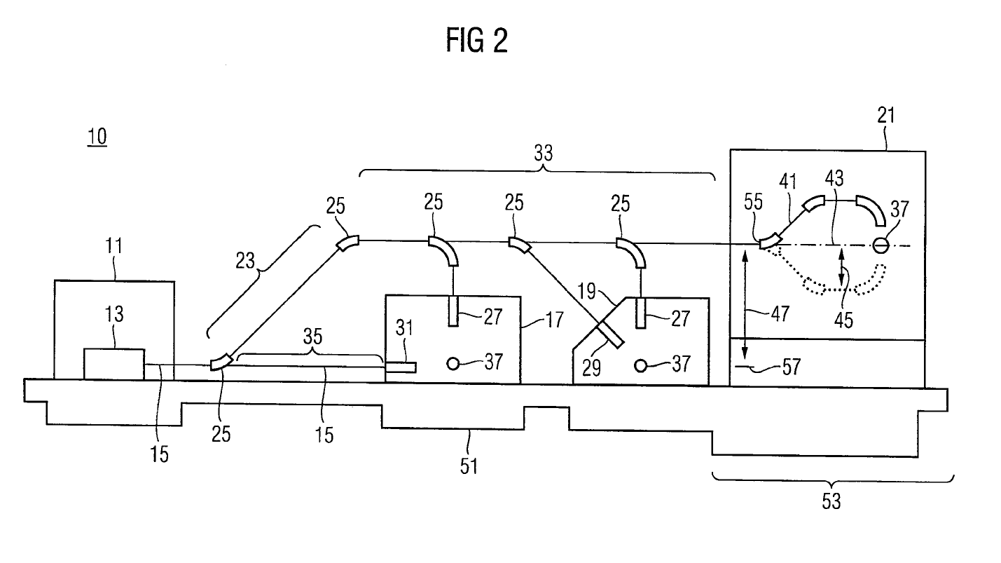

FIG. 2 schematically shows the particle therapy system 10 in which a gantry-based radiation room 21 may be operated instead of the third radiation room 19′. The gantry-based radiation room 21 is disposed in such a way that it is connected to the first subarea 23 of the particle beam transport system 15, or more precisely to the section 33 in which the particle beam transport system 15 is once again routed horizontally.

The gantry-based radiation room 21 has a guidance system for the particle beam which can be rotated about an axis 43. This enables the irradiation angle of the particle beam to be adjusted over a wide angular range. The radius 45 of the gantry 41 is less than a height difference 47 between the entry point 55 of the particle beam transport system 15 into the gantry 41 and the level 57 of the accelerator unit 13. For example, the level of the particle beam may be guided out of the accelerator unit 13 and not be subjected to any vertical deflection. A dimensioning of the gantry radius 45 may permit the gantry-based radiation room 21 to be installed without additional lowering of the building foundations 51 underneath the gantry. An adjustment of the height of the gantry 41 to the first subarea 23 of the particle beam transport system will be effected via a plinth 49 or some other elevated supporting member.

The particle therapy system 10 may be initially built without the gantry-based radiation room 21 and the gantry-based radiation room 21 is retrofitted, this allows a comparatively simple retrofitting, even if the exact specifications necessary for the gantry-based radiation room 21 are not known in every detail at the time of the building of the particle therapy system 10.

While the invention has been described above by reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

1. A particle therapy system, the system comprising:
an accelerator unit for accelerating particles and for providing a particle beam,
a particle beam transport system for guiding the particle beam provided by the accelerator unit, the particle beam transport system having a first subarea by which the particle beam can be guided out from a level on which the accelerator unit is located, and
a gantry-based radiation room that is connected to the first subarea of the particle beam transport system.

2. The particle therapy system as claimed in claim 1, wherein the gantry-based radiation room has a gantry radius that is equal in size or less than a height difference between an entry point of the particle beam transport system into the gantry of the gantry-based radiation room and a level on which the accelerator unit is located.

3. The particle therapy system as claimed in claim 2, wherein the particle beam transport system includes a second subarea by which the particle beam can be guided essentially on the level of the accelerator unit, and a further radiation room is connected to the second subarea.

4. The particle therapy system as claimed in claim 3, wherein the first subarea of the particle beam transport system includes a section by which the particle beam can be guided essentially horizontally.

5. The particle therapy system as claimed in claim 4, wherein the gantry-based radiation room is connected to the horizontally routed section of the first subarea.

6. A particle therapy system, comprising foundations on which the particle therapy system are disposed, wherein the foundations are dimensioned at a point such that a gantry-based radiation room can be retrofitted at the point.

7. The particle therapy system as claimed in claim 6, wherein the particle therapy system comprises:
an accelerator unit for accelerating particles and for providing a particle beam; and
a particle beam transport system for guiding the particle beam provided by the accelerator unit,
wherein at the point at which the gantry-based radiation room can be retrofitted, the foundations are essentially located at the same height as the foundations which are located underneath the accelerator unit and underneath the particle beam transport system.

8. The particle therapy system as claimed in claim 7, wherein the particle beam transport system includes a first subarea by which the particle beam can be guided out from a level on which the accelerator unit is located.

9. A method for building a particle therapy system, comprising:
providing an accelerator unit for accelerating particles and for providing a particle beam,
providing a particle beam transport system for guiding the particle beam accelerated by the accelerator unit, wherein the particle beam transport system has a first subarea by which the particle beam can be guided out from a level on which the accelerator unit is located, and
connecting a gantry-based radiation room to the first subarea of the particle beam transport system.

10. A method for retrofitting a particle therapy system which comprises:
an accelerator unit for accelerating particles and for providing a particle beam,
a particle beam transport system for guiding the particle beam provided by the accelerator unit, wherein the particle beam transport system has a first subarea by which the particle beam can be guided out from a level on which the accelerator unit is located,
connecting a radiation room to the first subarea of the particle beam transport system.

11. The method as claimed in claim 10, wherein the radiation room is a gantry-based radiation room.

12. The particle therapy system as claimed in claim 6, wherein the particle therapy system comprises:
an accelerator unit for accelerating particles and for providing a particle beam; and
a particle beam transport system for guiding the particle beam provided by the accelerator unit,
wherein at the point at which the gantry-based radiation room can be retrofitted the foundations are essentially located at the same height as the foundations which are located underneath the accelerator unit.

13. The particle therapy system as claimed in claim 6, wherein the particle therapy system comprises:
an accelerator unit for accelerating particles and for providing a particle beam; and
a particle beam transport system for guiding the particle beam provided by the accelerator unit,
wherein at the point at which the gantry-based radiation room can be retrofitted the foundations are essentially located at the same height as the foundations which are located underneath the particle beam transport system.
